(19) United States
(12) Patent Application Publication
(10) Pub. No.: US 2026/0179016 A1
(43) Pub. Date: Jun. 25, 2026

(54) AUTOMATED DIGITAL COMMUNICATION SYSTEM

(71) Applicant: Express Scripts Strategic Development, Inc., St. Louis, MO (US)

(72) Inventors: Anirban Chowdhury, Frisco, TX (US); Paul Jerchaflie, Sparta, NJ (US); Mahipal Singareddy, Parsippany, NJ (US); Venkata K. Potturi, Argyle, TX (US)

(21) Appl. No.: 18/990,020

(22) Filed: Dec. 20, 2024

(51) Int. Cl. G06Q 10/0633; G06Q 10/0631

(52) U.S. Cl. CPC G06Q 10/0633; G06Q 10/06314

(57) ABSTRACT

Apparatuses, systems, and methods relate to technology to identify a plurality of user factors associated with a user, and determine, with a machine learning model, a future time to contact the user based on the plurality of user factors. The technology further includes determining, with a stacked ensemble, a probability that the user responds to digital outreach based on the plurality of user factors, and initiating an automatic contacting process to contact the user at the future time based on the probability meeting a threshold.

### TECHNICAL FIELD

The present disclosure relates to an automated communication system that automatically provides digital notifications. Examples can include a stacked ensemble and random forest classifier that guides and facilitates an electronic communication process by determining users that will be the most responsive to digital outreach, and the most appropriate time to contact the users.

### BACKGROUND

Telecommunications can include an electronic transmission of information over distances for different purposes. Telecommunication networks can support various technologies, including voice telephone calls, text messaging, chats, emailing, image sharing, applications, faxes, the internet, websites, video teleconferences, and/or video sharing. Telecommunications can include organizing computer systems into telecommunications networks. These networks themselves can be operated by computers.

### BRIEF DESCRIPTION OF THE SEVERAL VIEWS OF THE DRAWINGS

The various advantages of the embodiments of the present disclosure will become apparent to one skilled in the art by reading the following specification and appended claims, and by referencing the following drawings, in which:

FIG. 1 is a diagram of an example of a digital outreach process according to an embodiment;

FIG. 2 is a flowchart of an example of a method of determining whether to execute a digital outreach, a time to execute the digital outreach and updating weights for base models according to an embodiment;

FIG. 3 is a flowchart of an example of a method of training a stacked ensemble according to an embodiment;

FIG. 4 is a graph of an example of a standardized coefficient magnitudes scale according to an embodiment;

FIGS. 5A, 5B, 5C, 5D, 5E, 5F, 5G, 5H, 5I and 5J illustrates variable importances for inputs into the stacked ensemble according to various embodiments;

FIG. 6 illustrates an automated contacting process according to an embodiment;

FIG. 7 is a block diagram of an example of a computing system according to an embodiment;

FIG. 8 is a block diagram of an example stacked ensemble that may be deployed within the system of FIG. 1, according to some examples; and

FIG. 9 is a functional block diagram of an example neural network that can be used for the inference engine or other functions (e.g., engines) of a stacked ensemble as described herein to produce a predictive model.

### DETAILED DESCRIPTION

Examples relate to an enhanced and automated communication session process that results in increased user response, increased efficiency, reduced computing resource consumption and reduced bandwidth by optimization of whom to contact and when to contact a user. Examples are based on a cutting-edge, new and enhanced machine learning model system that can identify users that are most likely to respond to digital communications, and further identify a time to initiate the digital communication.

Different technologies may implement various forms of communications. For example, electronic mail (email), fax, software applications, websites, telephony and chat support rapid and efficient communication between users and various entities. These communication channels can include electronic communications means. Such technologies have rapidly increased in size, scope and magnitude as commensurate infrastructure has developed. The communication process can at least be partially automated. For example, users can be provided specific automated messages (e.g., notify users of changes in statuses of order, notify the users of new occurrences, push news, suggest downloading of new applications, suggest accessing particular websites to retrieve user data such as medical records, schedule deliveries, schedule appointments, confirm preferences, etc.). Such communication technologies are often convenient and provide valuable information but can be easily overlooked and ignored by users, resulting in an imperfect implementation that leads to reduced efficiency, increased load on computing systems, increased load on communication systems, poor computing performance, missed electronic notifications, frustration and incomplete processes.

For example, a notification can be provided to a user to download an application. The application supports easier access to data (e.g., user information and/or account details) as compared to websites and/or automated telephone systems, increased performance (e.g., applications can be faster than websites because they use the device's hardware and software to process data and store it locally), enhanced user experience (quicker access to features and streamlined processes), offline access (applications can work without an internet connection, providing access to content and features), integration (applications can access and use a computing device's built-in features, such as the camera or global position systems), customization (e.g., applications can be customized by users after they are downloaded), and notifications (applications can send notifications to push new products and share news). Therefore, downloading and using the application can be far more convenient and beneficial than utilizing other communication systems (e.g., websites, phone systems, etc.). If the notification is overlooked or ignored, the application will not be downloaded or utilized leading to the sub-optimal computing processes (e.g., through website) noted above.

The amount of overlooked automated messages can vary depending on several factors such as the content, timing, and recipient interest. In some cases, however, a significant portion (e.g., over 60%) of automated messages can be overlooked and/or ignored. In such cases, the automated messages are repeatedly resent until the user finally responds to the message or the automated notifications is determined to be ineffective and abandoned altogether. Doing so increases the burden on computing systems tasked with providing the messages since the messages are generated and transmitted by the computing system. Furthermore, the transmission of messages over a cellular network and/or internet can increase bandwidth as messages are repeatedly sent.

Moreover, messaging is not alone in terms of unresponsiveness. Between 35%-78% emails go unread, which can mean that every year 55 trillion emails are unread. Messaging (e.g., Short Message Service) has higher read rates than emails, but are often times not acted upon meaning that engagement rates still remain low. A relatively low amount (e.g., only about 30-40% of users) interact with mobile push notifications. Further, desktop and/or laptop push notifications can have even lower engagement. Chatbots are often ignored after users identify the chatbots as being automated. Timing deeply affects the effectiveness of automated notifications and can indicate whether the notifications (e.g., emails, messages, push notifications, chatbot messages) are to be resent.

As one example, entities can employ an active operations management (AOM) tool to auto-contact (e.g., auto-dialing which includes a system or feature of a system by which a device such as a telephone or computer automatically dials a preprogrammed telephone number) thousands of campaign recipients based on rudimentary, experts written rules (manually programmed by a person). Such expert rules lack specific tailoring for a particular user and are based on generalized characteristics of a whole population data set. Such expert rule formulations lack the intelligence, intuition and capabilities to be truly insightful leading to increased computing overhead (e.g., memory, processing, power consumption, etc. from repeatedly electronically contacting users to no avail), reduced reading rates, reduced notification rates, and increased bandwidth consumption (e.g., from repeatedly electronically transmitting notifications to a user). Furthermore, a human being would be unable to provide and understand such insights. For example, attempting to find the patterns in the existing patient data during a mental process of a human would be too arduous of a task for the human to complete in a reasonable amount of time over thousands if not millions of records. As described below, thousands of patient records were used to train machine learning models described herein. Similarly, for a human to discover the patterns within the training data set and program them into the expert system based on the data set features (like patient location, therapy, refills, coverage information) would also be too arduous of a task to program and maintain as data set features routinely and frequently change. That is, a human being would be unable to comprehend the patterns that drive particular populations of humans and influence read rates.

In contrast, enhanced examples herein can be based on machine learning models that reduce the complexity required to create and maintain the system. Enhanced examples herein focus on contacting users (e.g., patients) who are the most likely to be receptive to digital and automated communication, and utilizing digital channels to complete objectives (e.g., fill medical prescriptions, notify user of changes, download application, pickup package, register for online portal, test result notification, etc.). Examples herein leverage data science and machine learning predictive capabilities to detect the best time to contact a patient and detect which patients are most likely to use digital services. That is, examples can include an enhanced methodology and apparatus to determine the most effective users to electronically contact and times to contact the users by leveraging the powerful capabilities of machine learning to increase read rates, reduce bandwidth (less notifications sent due to greater rates of success), reduce processing power (less notifications are generated and pushed by computing systems), reduce memory consumption (successful automatic notifications outreach can remove data relating to the automatic notifications from computing systems), and enhance user experience.

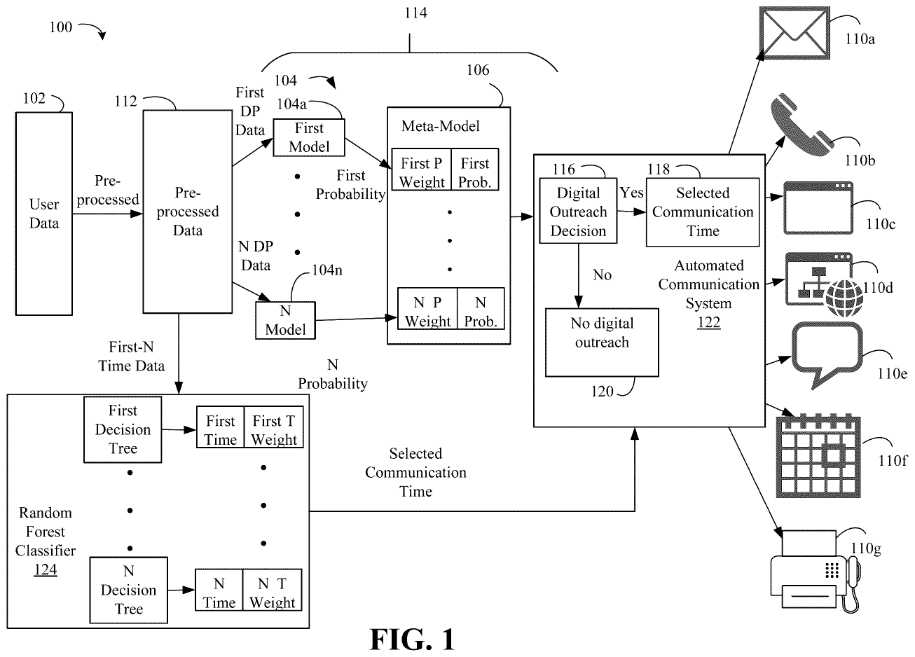

Examples can use a unique combination of machine learning models to obtain a most efficient outcome. In detail, a stacked ensemble (comprises many different machine learning models) predicts the digital propensity of a patient. The digital propensity is used to make a digital outreach decision. A random forest classifier (comprises many different decision trees) predicts the optimum time to digitally contact a patient. The optimum time is used to select the communication time. The combination of the random forest classifier and the stacked ensemble creates a synergistic effect that significantly increases successful digital outreach outcomes with reduced computing resources. Turning now to FIG. 1, a digital outreach process 100 is illustrated. User data 102 can be gathered from numerous different databases and sources. For example, user data 102 can be obtained from different sources including online repositories, databases, etc. The user data 102 can be particular to a user (e.g., specific characteristics and/or descriptions of the user). In some examples, the user data 102 can include data that relates to shopping history of a user, demographics of the user (e.g., age, gender, income, education, marital status, location, family structure, etc.), health history of the user, internet browsing history of the user, previous responsiveness of the user to electronic messages, etc. While a single user is described below, it will be understood that that digital outreach process 100 can be executed for other users (e.g., first user, second user, third user, etc.) and executed in parallel.

To operate with enhanced efficiency and be able to identify the users that would be the most responsive to electronic notifications as well as the timing of such electronic notifications, examples pre-process the user data 102. For example, previous automated contacting processes are based on exact user data and expert rules (non-machine learning rules). Such previous automated contacting processes have sub-optimal results (lower responsiveness) and result in increased processing power (increased notifications are generated and pushed by computing systems), increased memory consumption (unsuccessful automatic notification outreach results in user data being stored for longer periods of time), and reduced user experience.

Enhanced processes and structures described herein can pre-process the granular data to place the data into categories, ranges and/or bins. Providing the categorized data, binned data and/or ranges (e.g., user is between ages 40-50, user utilizes cardiovascular therapies) to a stacked ensemble 114 and random forest classifier 124 enhances the accuracy of predictions of the stacked ensemble 114 and random forest classifier 124 as opposed to providing more granular and exact information (e.g., user is 45 years old, user controls blood pressure with medication X). The pre-processing can occur with a machine learning model(s) that in trained to extract specific information from the user data 102 and generate categorized data, bucketed data and/or ranges based on the specific information.

In some examples, if the environment of the digital outreach process 100 is in a certain industry (e.g., health care), the user data 102 can be pre-processed for patient identification, previous automated call dates, previous call time phases, previous call type, call results category (whether the previous automated calls were successful in soliciting an intended reaction from the user such as download an application) and therapy type code (e.g., a code for a therapy of the user). Further, and as noted above, rather than providing an exact time of successful contacts and/or time for unsuccessful contacts, examples can place the times into bins. For example, TABLE I can provide the different buckets (time ranges):

TABLE I

| Time range | Call phase |
|---|---|
| 8-12 | Morning |
| 12-16 | Afternoon |
| 16-22 | Evening |

Equation 1 below can be used to calculate the appropriate time range based on an actual time that the contact (e.g., telephone call) occurred:

$$Eastern Standard Time = ( HOUR + MINUTES / 60 ) + OFFSET \qquad EQUATION I$$

The OFFSET in EQUATION I is an adjustment to convert the actual time from a time zone (e.g., pacific standard time or PST) into eastern standard time (EST). Doing can enhance the accuracy of the later described machine learning processing.

In some examples, the pre-processing can include standardizing names of columns for “in” and “out” data. The pre-processing can further include removing special characters across fields (e.g., nan, ?, inf, etc.).

The user data 102 can be adjusted from an unstructured format to a structured format. In some examples, adjustment to the structured format can include introducing additional fields (e.g., external mapping files) to a therapeutic resource center (based on therapy codes), business unit, therapy class, region (based on state code), division, gender, mapping each column to a numerical value so as to be consumed by stacked ensemble 114 and random forest classifier 124, standardizing names of columns as per training data, and introduces 21 records for the user to cover all scenarios (e.g., seven days (Monday-Sunday) and three binned time slots during each day such as morning, afternoon and evening). The field business unit can be generated by joining datasets across the organization. For example, several datasets can exist, for example a first dataset with patient call information, and a second dataset (separate from the first dataset) with some metadata that may be relevant and serve as suitable predictors in models herein. Examples can join the metadata from the second database and the patient call information from the first database using identifiers like Patient ID or some other ID or mapping.

As will be explained below, the model used for calculating the best time to contact a user is the random forest classifier 124. The stacked ensemble 114 is used to predict the digital propensity of the user.

Examples can map the data (e.g., alphabet format and/or alphanumeric format) to a numerical value because strings (or word representation of data) are not easily understood by the stacked ensemble 114 and the random forest classifier 124 that are used. The data is encoded into a numerical value so the stacked ensemble 114 and random forest classifier 124 can understand inputs. One-hot encoding can be an example of this.

For example, the additional features can include a binned age (e.g., created additional feature-binned age using date of birth field). An example of binned ages categories is shown below in TABLE II:

TABLE II

| Age range | Age bin category |
|---|---|
| 0-20 | Kids_Children_Teens |
| 20-40 | Youth |
| 40-60 | Middle_Group |
| 60-80 | Old |
| 80-120 | Very Old |

Some examples can also map each column to a numerical value so as to be consumed by the stacked ensemble 114 and/or random forest classifier 124. For example, each value in the columns can be assigned a numerical value that can be consumed by the stacked ensemble 114 rather than a free text description.

Moreover, only a part of the user data 102 can be selected to be part of the pre-preprocessed data 112. For example, data that has limited value (e.g., eye color, relatives' names, etc.) can be discarded while the more informative data (e.g., therapies, location, age, shopping history, responsiveness to previous digital outreach, application usage, mobile device usage habits, health plan, etc.) from the user data 102 can be stored as part of the pre-preprocessed data 112. In some examples, the user data 102 can pertain to only the user. The pre-preprocessed data 112 can include a disease of the user, whether the user has a pulmonary condition, a therapy of the user, a growth disorder of the user, genetic disorder of the user, or a provider (medical provider) of the user.

In this example, first data propensity (DP) data to N DP data from the pre-preprocessed data 112 (e.g., user factors) can be provided to a stacked ensemble 114. The stacked ensemble 114 can comprise a first layer of machine learning models 104a-104n which can be referred to as base models 104. The first layer can include any number of machine learning models 104a-104n. The machine learning models 104a-104n can be different from each other (e.g., decision trees, support vector machines, deep learning networks, neural networks, etc.) and trained differently from each other. For example, each of the machine learning models 104a-104n can receive different subsets of the pre-preprocessed data 112. That is, the first model 104a can receive first data (e.g., therapies of the user and whether user previously responded to digital outreach), while the N model 104n can receive N data (e.g., demographic data of the user). The first and N data can be different from each other (e.g., include different characteristics, attributes, etc.). Other models (unillustrated) of the first model 104a-N model 104n can receive other subsets of the pre-preprocessed data 112 (e.g., a second model can receive second data, a third model can receive third data, etc.). The base models 104 can include decision trees, support vector machines, gradient boosting machine and neural networks among others. In some examples, the subsets of data can be weighted so that the first model 104a-N model 104n are more influenced by some factors as opposed to others.

The stacked ensemble 114 incorporates several distinct learning algorithms (which are embodied as base models 104) to obtain enhanced and more accurate predictive performance than could be obtained from only a single one of the distinct learning algorithms. That is, the stacked ensemble 114 assembles a collection of weak learners and combines the weak learners to form a single, strong learner.

The first model 104a-N model 104n (e.g., “base learners”) can generate predictions based on the first-N data. The predictions can include whether the first user is likely to respond to a digital outreach (digital propensity, can be in a likelihood or percentage format). For example, each of the machine learning models 104a-104n can output a score (e.g., probability) indicating if a person will respond to digital outreach. The scores generated by the first model 104a-N model 104n can be provided to a meta-model 106. The scores are shown as the first probability-N probability.

The meta-model 106 combines the predictions (First probability-N probability) to determine whether the user will be responsive to a digital outreach, and if so a time to execute the digital outreach. The meta-model 106 can be a Linear Regression model for regression tasks and/or Logistic Regression Model for classification tasks.

To do so, the meta-model 106 can weigh the outputs from the first model 104a-N model 104n. That is, examples can identify (e.g., during training) accurate models from the first model 104a-N model 104n that have provided the highest accuracy and increase the “votes” (probabilities) of those accurate models. The weights can be generated during training of the meta-model 106 and are locked during inference. The first probability (P) weight-N P weight are for weighing the first-N probabilities (probability of whether the digital outreach will be successful). The weighting can occur in a 1-1 fashion, meaning that the first P weight is applied to the first probability, the second P weight is applied to the second probability, etc.

The first P weight-N P weight and the first T weight-N T weight can be adjusted based on the accuracy of corresponding base models 104 to increase or decrease the influence of the base models 104 in the decision-making process. For example, suppose that the first model 104a determines that a first user will not respond to digital communication (first probability is below a threshold such as 50%), but ultimately the meta-model 106 determines that digital outreach should be executed based on other predictions (e.g., corresponding probabilities above the threshold) of the base models 104 (e.g., based on predictions from the second model-N model 104n). Further, suppose that the digital outreach is executed and is unsuccessful (e.g., first user does not respond to digital outreach), the first P weight applied to the first probability generated by the first model 104a can be increased while other models that predicted that the first user will respond to digital outreach (generated probabilities above the threshold of 50%) will have corresponding P weights decreased.

Similarly suppose that the first model 104a determines that a second user will respond to digital communication (first probability is above the threshold). In this example, the meta-model 106 determines that the second user will respond to digital outreach based on the first-N probabilities. If the outreach is executed and is successful (e.g., second user does respond to digital outreach that is transmitted at the particular time), the first P weight can be increased based on the accuracy of the first probability, while other models that had different predictions (e.g., the second user will not respond to digital outreach) can have corresponding weights (probabilities and weights) decreased. If however the outreach is executed and is unsuccessful (e.g., second user does not respond to digital outreach), the first P weight can be decreased based on the inaccuracy of the first probability. The above weight adjustments of the first P weight to N P weight can occur during training. The meta-model 106 can provide a digital outreach decision 116 based on the first-N probabilities and the first P weight-N P weight.

The random forest classifier 124 can receives first-N time (T) data from pre-preprocessed data 112. The first-N time data can be user factors related to determining a specific time to contact the user. The first DP data-N DP data can be different from the first-N T data. The random forest classifier 124 can be a machine learning algorithm that uses multiple decision trees to classify data into different groups and generate a selected communication time 118 (e.g., predicted time or future time) based on the first-N T data. The multiple decision trees can include first-N decision trees. The first decision tree can generate a first time based on a first subset of the first-N time data, a second decision tree can generate a second time based on a second subset of the first-N time data and so on until the N decision tree generates an N time based on an N subset of the first-N time data. The first-N subsets can be different from each other. The first time and N time can be time ranges, bins, or buckets. Similarly to as above, the first time to N time can be different from each other.

The first time-N time can be weighed with first T weight-N T weight. That is, the random forest classifier 124 can weigh the outputs from the first-N decision trees. Examples can identify (e.g., during training) accurate decision trees from the first-N decision trees that have provided the highest accuracy and increase the “votes” (probabilities) of those accurate decision trees. The first T weight-N T weight can be generated during training of the random forest classifier 124 and are locked during inference. The first T weight-N T weight are for weighing the first-N times (time for when a digital outreach is most likely to be successful). The weighting can occur in a 1-1 fashion, meaning that the first T weight is applied to the first time, the second T weight is applied to the second time, etc.

The first T weight-N T weight can be adjusted based on the accuracy of corresponding decision trees to increase or decrease the influence of the decision trees in the decision-making process. For example, suppose that the first decision tree determines that a first user will respond to digital communication at a first time. Suppose that ultimately the random forest classifier 124 determines that the user is to be contacted at a second time. If the user responds to the digital outreach at the second time, the influence (first T weight can be decreased) of the first decision tree in the decision making process can be decreased.

Suppose however that the random forest classifier 124 determines that the user will be contacted at the first time, and that the user responds to the digital outreach at the first time. The first T weight can be increased to increase the influence of the first decision tree in the decision-making process of the random forest classifier 124. If the user however did not respond to the digital outreach at the first time, the first T weight can be decreased to reduce the influence of the first decision tree. Each of the first-N decision trees of the random forest classifier 124 can have associated weights that increase or decrease the influence of the decision trees. The random forest classifier 124 can generate a selected communication time 118 based on the first time-N time as weighted by the first T weight-N T weight and provide the same to the automated communication system 122.

In this example, the digital outreach process 100 transmits the digital outreach decision 116 and the selected communication time 118 to an automated communication system 122. The digital outreach decision 116 can be generated based on the first probability-N probability as weighted by the first P weight-N P weight. If the digital outreach decision 116 is that a digital outreach should be performed, the selected communication time 118 is used to determine when to perform the automated digital outreach. The selected communication time 118 can be a bin of times (e.g., 8 AM-11 AM, 11:01 AM-2 PM, etc.) during which the digital outreach can be executed. Thus, the selected communication time 118 can be a range of times. The selected communication time 118 can be generated based on the first-N times as weighted by the First T weight-N T weight.

The digital outreach can adopt various communication forms, including transmitting a text message and/or chat 110e to a computing device of the user, executing an automated call 110b to the computing device, transmitting an electronic mail 110a to an email account of the user, providing a notification through an application 110d of the computing device, providing a notification through a website 110c, transmitting a fax 110g to the user, and/or updating an electronic calendar 110f of the user to indicate that a digital outreach is scheduled at the selected communication time 118. Thus, an automated process to conserve resources (computing resources and bandwidth), efficiently reach out to the user and increase success rates is performed to remedy the problems exhibited in the previous automated contacting processes.

If the digital outreach decision 116 is that no digital outreach 120 is to be initiated, then the automated communication system 122 conducts no digital communication. In such a case the automated communication system 122 can conserve resources by avoiding any digital outreach and bypasses (does not send) a notification through electronic mail 110a, automated call 110b, website 110c, application 110d, text message and/or chat 110e, electronic calendar 110f, and fax 110g.

The digital outreach process 100 can enhance existing systems by including a new and stacked ensemble 114 that is specifically trained to determine whether to execute digital outreach, and a random forest classifier 124 that generates a selected time to execute the digital outreach. Therefore, examples selectively execute the digital outreach only in situations where the stacked ensemble 114 determines that such digital outreach will be successful to conserve resources (e.g., bandwidth, computing resources, processing power, etc.) that would otherwise be spent on unsuccessful digital outreach. That is, systems that rely on expert rules to determine when to execute digital outreach and/or systems that always execute digital outreach utilize significantly greater resources with diminished returns as compared to the digital outreach process 100.

Moreover, examples not only determine whether digital outreach should occur, but an optimal time to conduct the digital outreach process. In particular, the combination of the stacked ensemble 114 and random forest classifier 124 can provide a synergistic effect that provides significant enhancements over conventional approaches.

The network(s) connecting the various components of communication session analysis digital outreach process 100 can include, or operate in conjunction with, an ad hoc network, an intranet, an extranet, a virtual private network (VPN), a local area network (LAN), a wireless network, a low energy Bluetooth (BLE) connection, a WiFi direct connection, a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network can include a wireless or cellular network and the coupling can be a Code Division Multiple Access (CDMA) connection, a Global System for Mobile communications (GSM) connection, or other type of cellular or wireless coupling. In this example, the coupling can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

Aspects of the digital outreach process 100 can be implemented be implemented in logic instructions (e.g., software), configurable logic, fixed-functionality hardware logic, computer readable instructions stored on at least one non-transitory computer readable storage medium that are executable to implement aspects of the digital outreach process 100, circuitry, etc., or any combination thereof. The digital outreach process 100 can be a computing architecture, in which any of the components are executed in logic instructions (e.g., software), configurable logic, fixed-functionality hardware logic, computer readable instructions stored on at least one non-transitory computer readable storage medium that are executable to implement on the communication session analysis architecture digital outreach process 100, circuitry, etc., or any combination thereof.

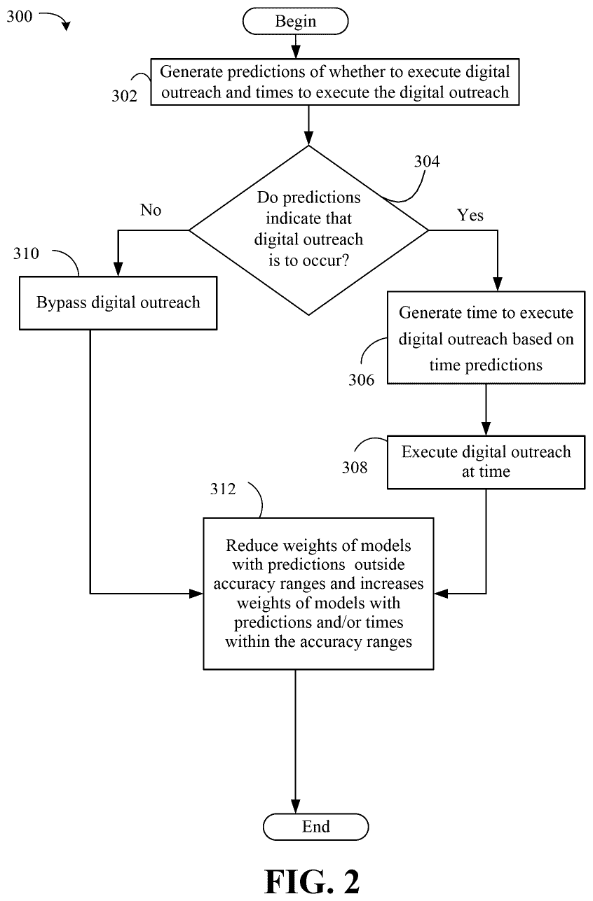

FIG. 2 illustrates a method 300 that determines whether to execute a digital outreach, a time to execute the digital outreach and update weights for base models. The method 300 can generally be implemented in conjunction with any of the embodiments described herein, for example the digital outreach process 100 (FIG. 1). In an embodiment, the method 300 is implemented in logic instructions (e.g., software), configurable logic, fixed-functionality hardware logic, computer readable instructions stored on at least one non-transitory computer readable storage medium that are executable to implement method 300, circuitry, etc., or any combination thereof.

Illustrated processing block 302 generates predictions of whether to execute digital outreach and times to execute the digital outreach. The predictions and times can be generated with base models, such as base models 104 (FIG. 1). Illustrated processing block 304 can determine if the predictions indicate that digital outreach is to occur. Illustrated processing block 304 can be executed with the meta-model 106 (FIG. 1) through a weighted process. If digital outreach is to occur, illustrated processing block 306 generates a time to execute the digital outreach based on the times generated in processing block 302, and illustrated processing block 308 executes a digital outreach at the time. Processing block 306 can be executed with the random forest classifier 124 (FIG. 1), and processing block 308 can be executed with the automated communication system 122 (FIG. 1). If the predictions indicate that digital outreach should not occur, illustrated processing block 310 bypasses the digital outreach. Processing block 310 can be performed with the automated communication system 122.

Illustrated processing block 312 reduces weights of models (decision trees and/or base models) with predictions and/or times outside accuracy ranges and increases weights of models with predictions and/or times within the accuracy ranges. For example, if a first decision tree provided a time (e.g., 3 hours off from successful contact time), a weight applied to the time of the first decision tree can be reduced; in contrast if a second decision tree provided a time that was similar to the successful contact time, a weight applied to the time of the second decision tree can be increased. Similarly, weights of the predictions can be updated based on the accuracy of the predictions as compared to the actual digital outreach. That is, the meta-model that executes processing block 304 can have parameters (weights) updated based on the accuracy of the predictions of the base models.

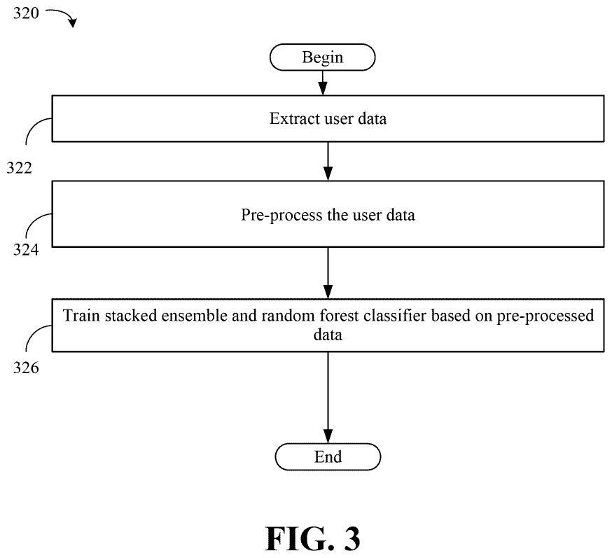

FIG. 3 illustrates a method 320 that trains a stacked ensemble, such as stacked ensemble 114. The method 320 can generally be implemented in conjunction with any of the embodiments described herein, for example the digital outreach process 100 (FIG. 1) and/or the method 300 (FIG. 2). In an embodiment, the method 320 is implemented in logic instructions (e.g., software), configurable logic, fixed-functionality hardware logic, computer readable instructions stored on at least one non-transitory computer readable storage medium that are executable to implement method 320, circuitry, etc., or any combination thereof.

Examples use key data points about our users (e.g., patients), to be able to assemble a data set of patients who have and have not used our digital services and use that data to train a series of predictive models. The models are able to take key data points from a patient who has not yet used digital services, and output a score of that patient's likelihood to use digital services.

Illustrated processing block 322 extracts user data from a multitude of databases. Illustrated processing block 324 pre-processes the user data. Illustrated processing block 324 can include patient identification, a call date where the patient was reached, a call time phase, a month and day, day of the week that a call was placed, a call type, a patient age, therapy types of the patient, a Patient State or Province Code (e.g., TX, NJ, NY, etc.), a patient gender, a patient type, a therapy class (e.g., an illness for which the patient is seeking treatment, for example Multiple Sclerosis, Asthma, Osteoporosis, etc.), a current therapeutic resource center (e.g., neurology and multiple-sclerosis, asthma and allergy, Endocrine), a business unit (e.g., the group within the company responsible for administering the patient (Adv-ther, Acdo-ther), a Region, Division and age bin for the user. Illustrated processing block 326 trains the stacked ensemble and the and random forest classifier based on the pre-processed data.

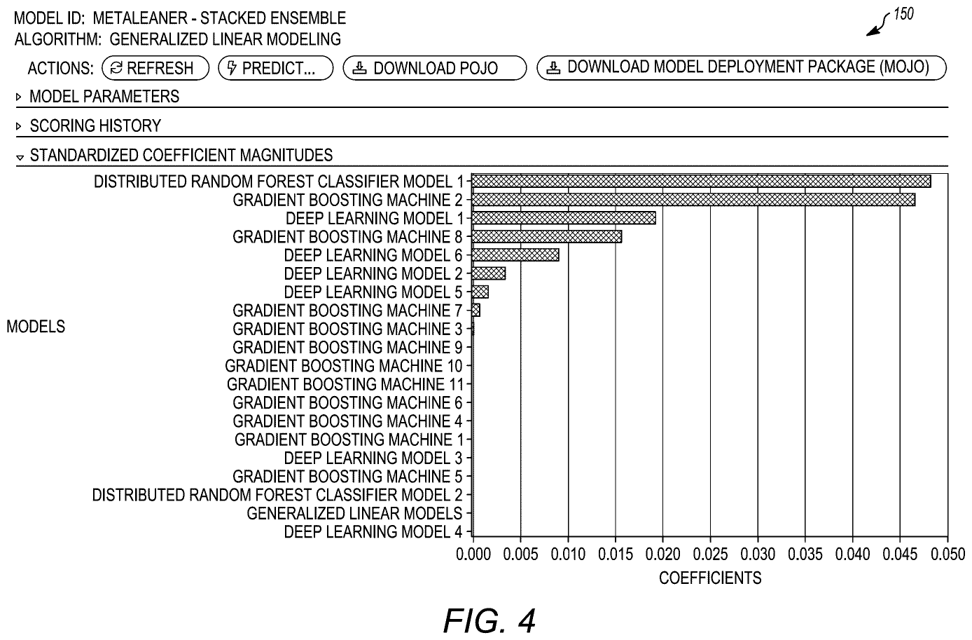

FIG. 4 illustrates a standardized coefficient magnitudes scale 150 to weigh the outputs (probabilities and times) of different machine learning models (base models) such as base models 104 (FIG. 1). The standardized coefficient magnitudes scale 150 can generally be implemented in conjunction with any of the embodiments described herein, for example the digital outreach process 100 (FIG. 1), the method 300 (FIG. 2) and/or method 320 (FIG. 3). The meta-model 106 (FIG. 1) can implement and/or access the standardized coefficient magnitudes scale 150 to scale the outputs (probabilities and times) of the base models 104.

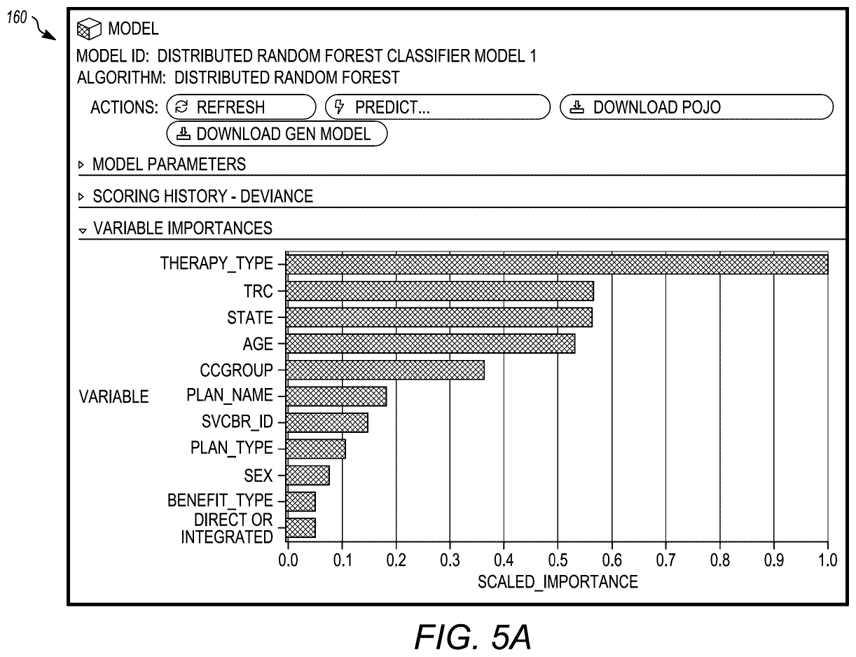

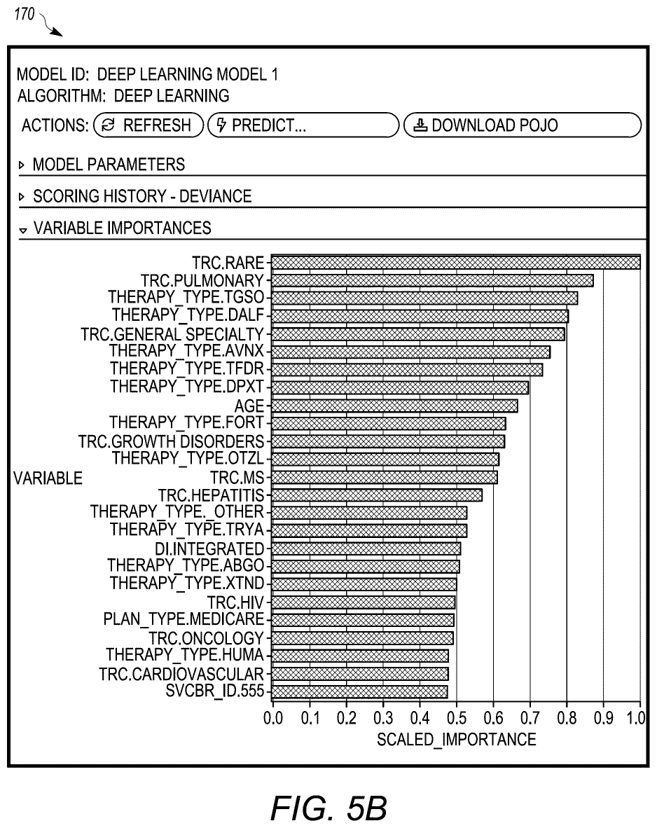

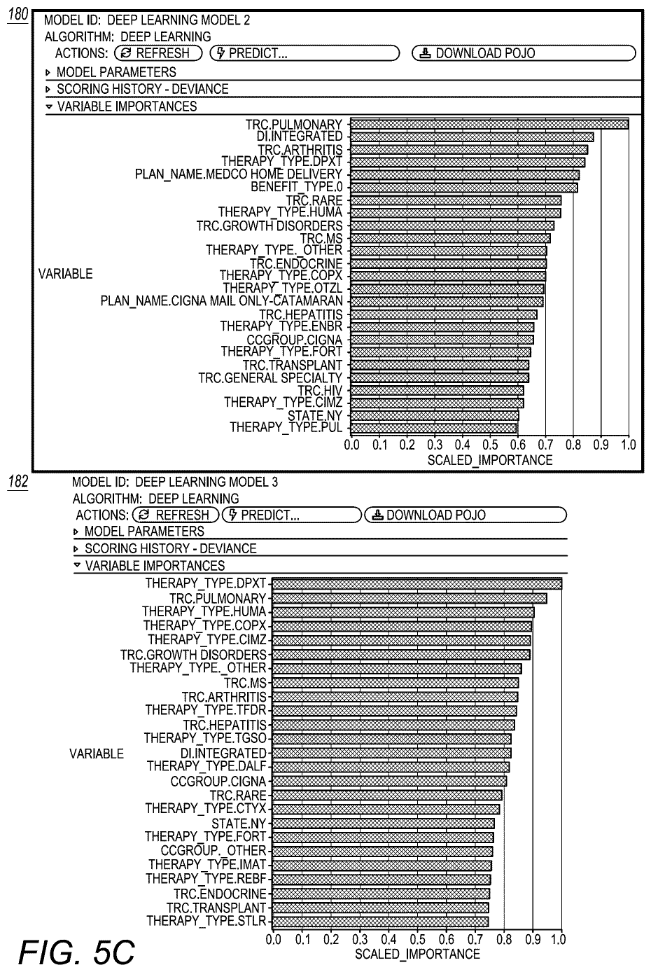

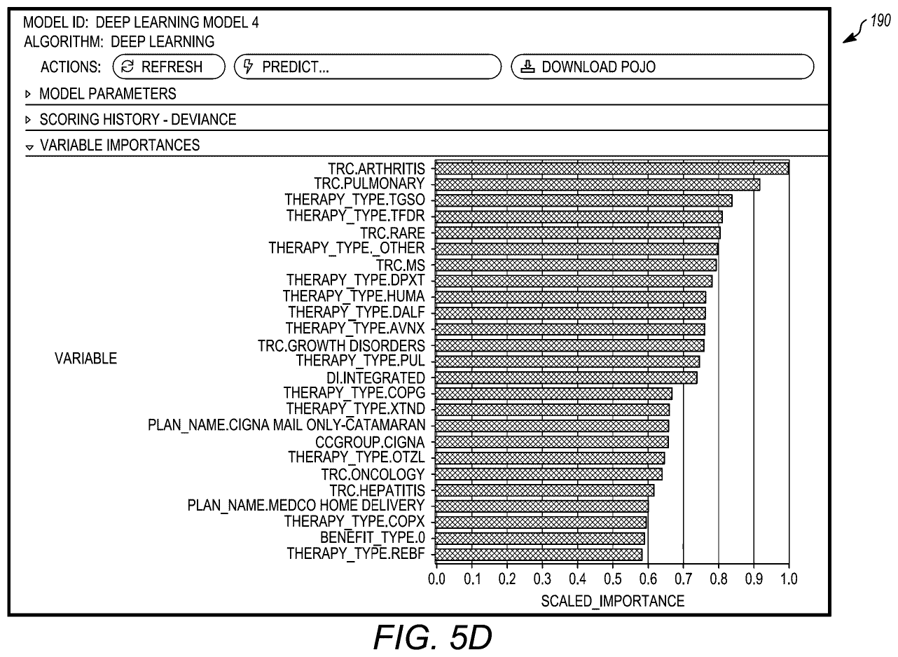

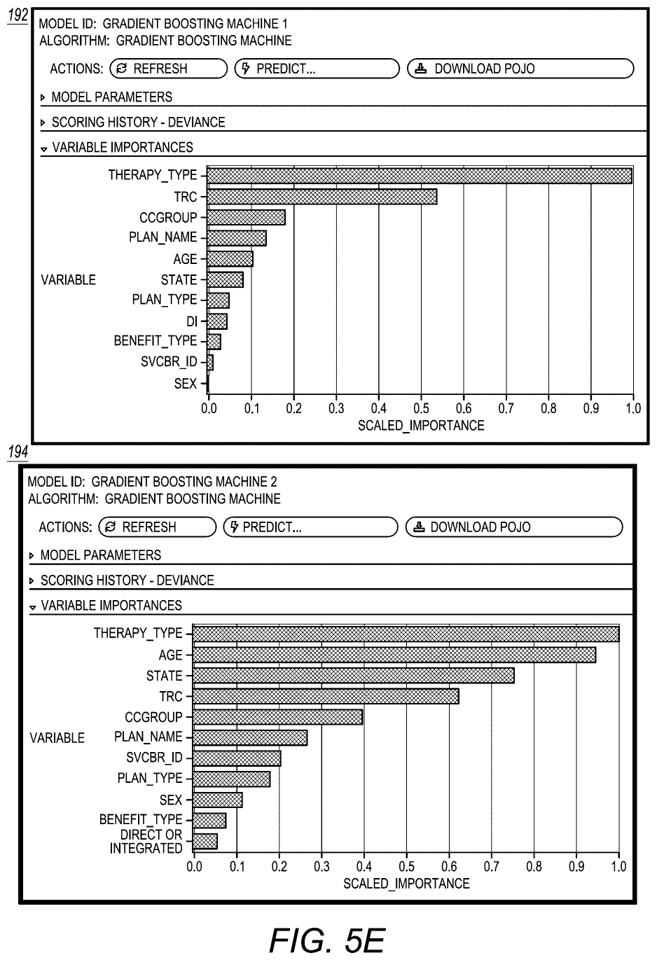

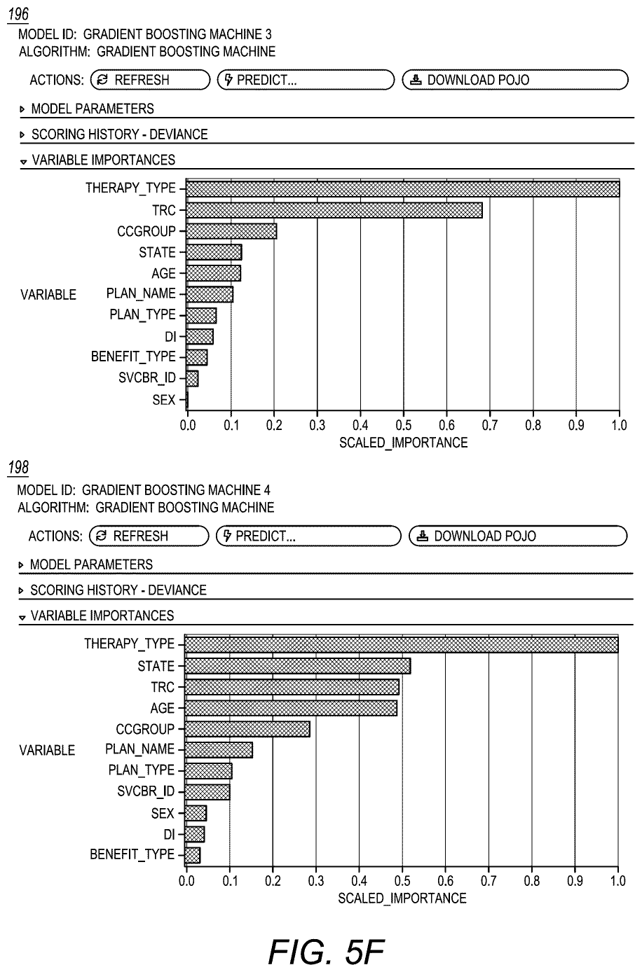

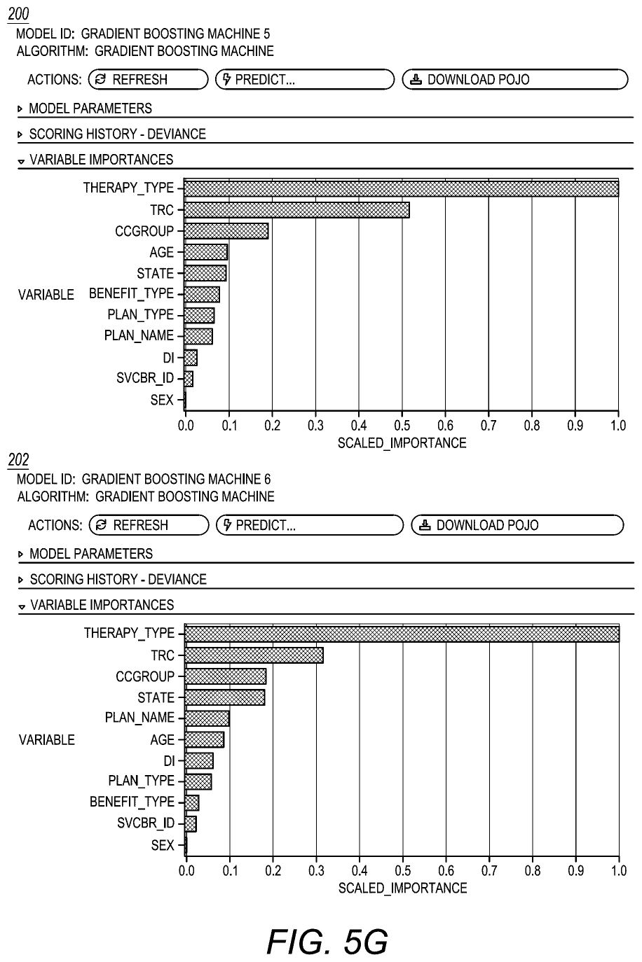

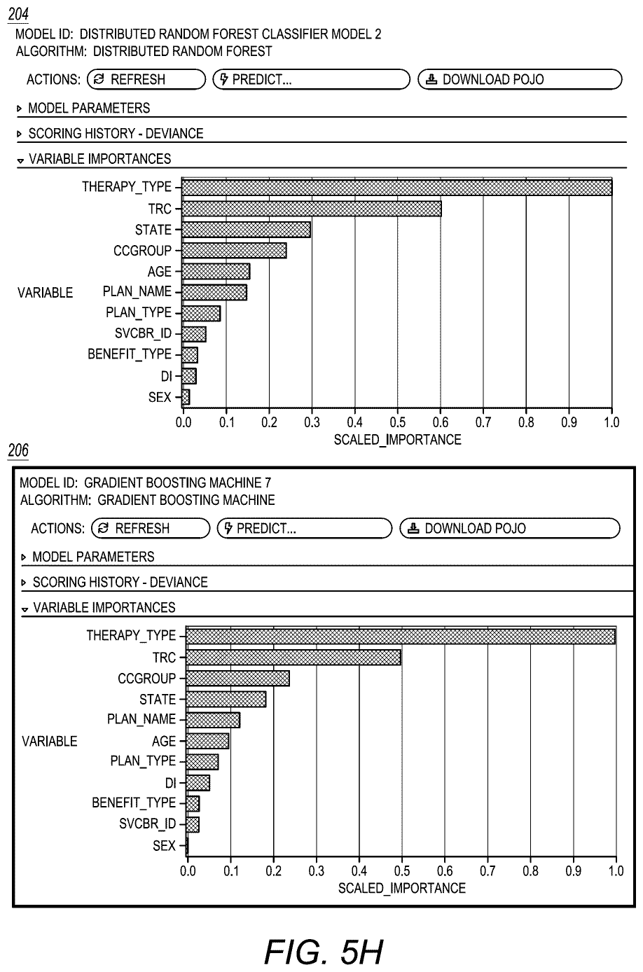

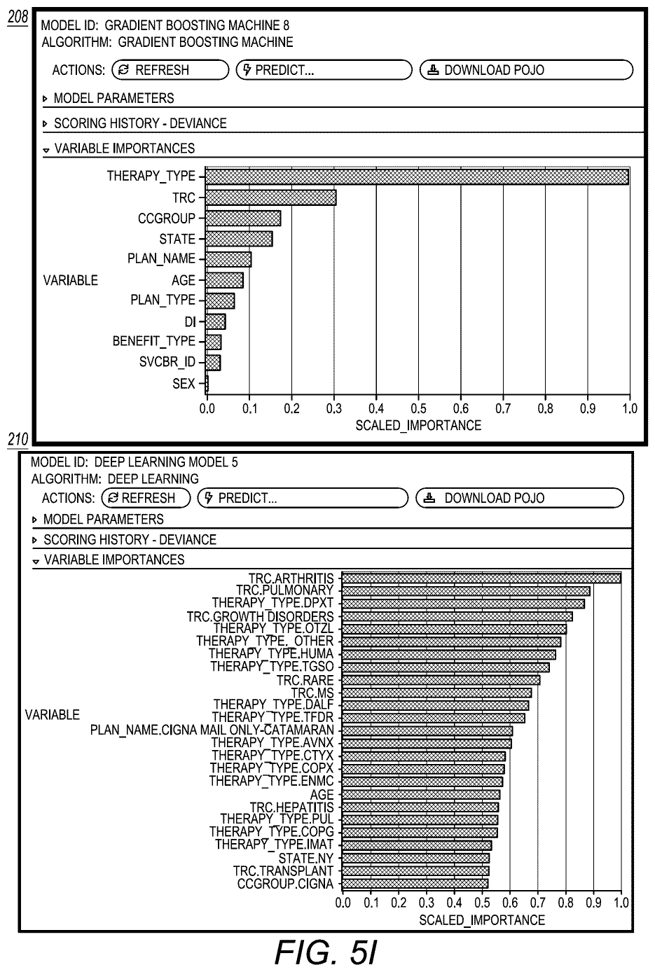

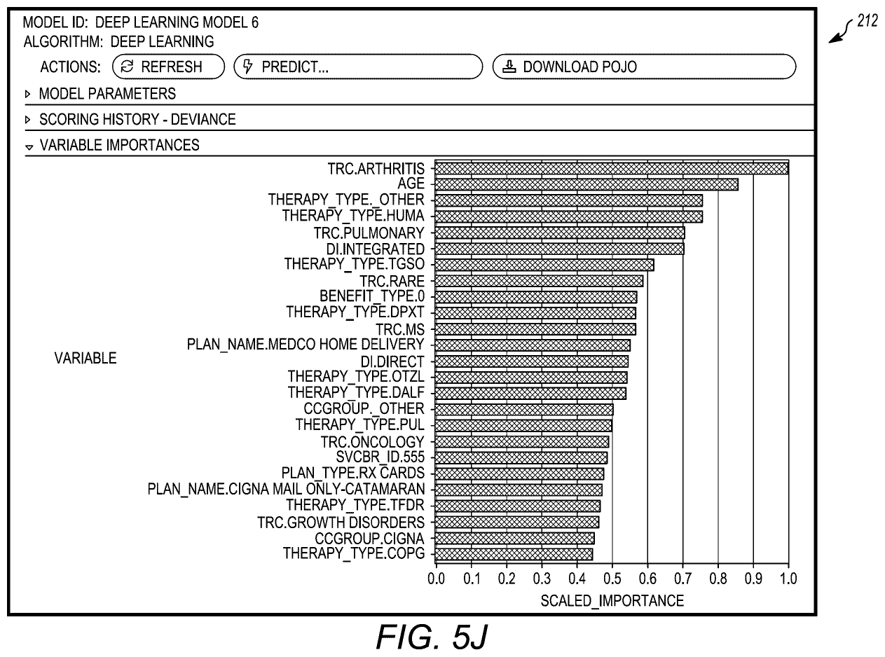

In this example, the algorithm employed is a “generalized linear modeling.” As shown in standardized coefficient magnitudes scale 150, the higher the coefficient, the more impact a corresponding model has in the stacked ensemble. For example, a meta-model that combines outputs from the listed models will place greater importance on outputs of models that have higher coefficients as opposed to outputs from models with lower coefficients. Models in the following FIGS. 5A-5H have been highlighted from the standardized coefficient magnitudes scale 150. As illustrated, the top eight models (Distributed Random Forest Classifier Model 1 to Gradient Boosting Machine 7) are heavily weighted, while the bottom machine learning models (around twelve stretching from Gradient Boosting Machine 3 to Deep Learning Model 4) have little to no coefficient meaning that the bottom machine learning models have almost no influence on the decision making process of a meta-model, such as meta-model 106 (FIG. 1) and are weighted at or close to zero by the meta-model. The coefficients can be adjusted in real-time based on performance of the models during inference and which models are most successful in identifying when and whether to execute digital outreach. In some examples, the models include decision trees, support vector machines, gradient boosting machine and neural networks.

FIG. 5A illustrates a first variable importance 160 to weigh different variables (e.g., factors) such as pre-processed data (pre-preprocessed data 112 of FIG. 1) provided to base models 104 (FIG. 1), and in particular to the first machine learning model (Distributed Random Forest Classifier Model 1) listed in the standardized coefficient magnitudes scale 150 (FIG. 4). The first variable importance 160 can generally be implemented in conjunction with any of the embodiments described herein, for example the digital outreach process 100 (FIG. 1), the method 300 (FIG. 2), method 320 (FIG. 3) and/or standardized coefficient magnitudes scale 150 (FIG. 4).

In this example, the distributed random forest classifier model 1 (can be a base model) receives several factors from pre-preprocessed data, which can be the pre-preprocessed data 112. The factors are weighted with a “scaled importance” as shown in first variable importance 160 to increase the effectiveness of the distributed random forest classifier model 1. It will be understood that random forest classifier models can include decision trees, including the distributed random forest classifier model 1. The scaled importance can weigh the different factors. For example, direct or integrated can mean whether a patient (that is subject to a digital outreach analysis process above) is a direct customer (e.g., receives services through a marketplace plan) or integrated customer (e.g., part of an entity or utilize a service directly offered by the entity) of the entity execute the digital outreach. The distributed random forest classifier model 1 can receive the factors and generate a probability (e.g., digital propensity) based on the factors.

FIG. 5B illustrates a second variable importance 170 to weigh different variables (e.g., factors) such as pre-processed data (pre-preprocessed data 112 of FIG. 1) provided to base models 104 (FIG. 1), and in particular the third machine learning model (Deep Learning Model 1 listed in the standardized coefficient magnitudes scale 150 (FIG. 4)). The second variable importance 170 can generally be implemented in conjunction with any of the embodiments described herein, for example the digital outreach process 100 (FIG. 1), the method 300 (FIG. 2), method 320 (FIG. 3), standardized coefficient magnitudes scale 150 (FIG. 4) and/or first variable importance 160 (FIG. 5A).

In this example, the deep learning model 1 (can be a base model) receives different factors from the pre-preprocessed data, which can be the pre-preprocessed data 112. The factors are weighted with a “scaled importance” as shown to increase the effectiveness of the deep learning model 1. The scaled importance can weigh the different factors. The deep learning model 1 can receive the factors and generate a probability (e.g., digital propensity) based on the factors.

FIG. 5C illustrates third variable importance 180 and fourth variable importance 182 to weigh different variables (e.g., factors) such as pre-processed data (pre-preprocessed data 112 of FIG. 1) provided to base models 104 (FIG. 1). The third and fourth variable importances 180, 182 can generally be implemented in conjunction with any of the embodiments described herein, for example the digital outreach process 100 (FIG. 1), the method 300 (FIG. 2), method 320 (FIG. 3), standardized coefficient magnitudes scale 150 (FIG. 4), first variable importance 160 (FIG. 5A) and/or second variable importance 170 (FIG. 5B).

In this example, a second deep learning model (can be a base model or the deep learning model 2 of FIG. 4) receives different factors illustrated in the third variable importance 180. The factors can be from the pre-preprocessed data, which can be the pre-preprocessed data 112. The factors are weighted with a “scaled importance” as shown to increase the effectiveness of the deep learning model 2. The scaled importance can weigh the different factors. The deep learning model 2 can receive the factors and generate a probability (e.g., digital propensity) based on the factors.

A third deep learning model (can be a base model or the deep learning model 3 listed in the standardized coefficient magnitudes scale 150 (FIG. 4)) receives different factors illustrated in the fourth variable importance 182. The factors can be from the pre-preprocessed data, which can be the pre-preprocessed data 112. The factors are weighted with a “scaled importance” as shown to increase the effectiveness of the Deep Learning Model 3. The scaled importance can weigh the different factors. The Deep Learning Model 3 can have little influence over the entire decision-making process as the Deep Learning Model 3 has a standardized coefficient magnitude in the standardized coefficient magnitudes scale 150 of zero. The Deep Learning Model 3 can receive the factors and generate a probability (e.g., digital propensity) based on the factors.

FIG. 5D illustrates a fifth variable importance 190 to weigh different variables (e.g., factors) such as pre-processed data (pre-preprocessed data 112 of FIG. 1) provided to base models 104 (FIG. 1). The fifth variable importance 190 can generally be implemented in conjunction with any of the embodiments described herein, for example the digital outreach process 100 (FIG. 1), the method 300 (FIG. 2), method 320 (FIG. 3) and/or standardized coefficient magnitudes scale 150 (FIG. 4), first variable importance 160 (FIG. 5A), second variable importance 170 (FIG. 5B), and/or third and fourth variable importance 180, 182 (FIG. 5C).

In this example, a fourth deep learning model (can be a base model or the Deep Learning Model 4 listed in the standardized coefficient magnitudes scale 150 (FIG. 4)) receives different factors illustrated in fifth variable importance 190. The factors are weighted with a “scaled importance” as shown to increase the effectiveness of the Deep Learning Model 4. The factors can be from the pre-preprocessed data, which can be the pre-preprocessed data 112. The scaled importance can weigh the different factors. The Deep Learning Model 4 can have little influence over the entire decision-making process as the fourth deep learning model has a standardized coefficient magnitude in the standardized coefficient magnitudes scale 150 of zero. The Deep Learning Model 4 can receive the factors and generate a probability (e.g., digital propensity) based on the factors.

FIG. 5E illustrates sixth variable importance 192 and seventh variable importance 194 to weigh different variables (e.g., factors) such as pre-processed data (pre-preprocessed data 112 of FIG. 1) provided to base models 104 (FIG. 1). The sixth variable importance 192 and seventh variable importance 194 can generally be implemented in conjunction with any of the embodiments described herein, for example the digital outreach process 100 (FIG. 1), the method 300 (FIG. 2), method 320 (FIG. 3), standardized coefficient magnitudes scale 150 (FIG. 4), first variable importance 160 (FIG. 5A), second variable importance 170 (FIG. 5B), third and fourth variable importance 180, 182 (FIG. 5C), and/or fifth variable importance 190 (FIG. 5D).

In this example, a first gradient boosting machine (can be a base model or the Gradient Boosting Machine 1 listed in the standardized coefficient magnitudes scale 150 (FIG. 4)) receives different factors illustrated in sixth variable importance 192. The factors are weighted with a “scaled importance” as shown to increase the effectiveness of the Gradient Boosting Machine 1. The scaled importance can weigh the different factors. The factors can be from the pre-preprocessed data, which can be the pre-preprocessed data 112. The Gradient Boosting Machine 1 can have little influence over the entire decision-making process as the first gradient boosting machine has a standardized coefficient magnitude in the standardized coefficient magnitudes scale 150 of zero. The Gradient Boosting Machine 1 can receive the factors and generate a probability (e.g., digital propensity) based on the factors.

In this example, a second gradient boosting machine (can be a base model or the Gradient Boosting Machine 2 listed in the standardized coefficient magnitudes scale 150 (FIG. 4)) receives different factors illustrated in seventh variable importance 194. The factors are weighted with a “scaled importance” as shown to increase the effectiveness of the Gradient Boosting Machine 2. The scaled importance can weigh the different factors. The factors can be from the pre-preprocessed data, which can be the pre-preprocessed data 112. The Gradient Boosting Machine 2 can receive the factors and generate a probability (e.g., digital propensity) based on the factors.

FIG. 5F illustrates eighth variable importance 196 and ninth variable importance 198 to weigh different variables (e.g., factors) such as pre-processed data (pre-preprocessed data 112 of FIG. 1) provided to base models 104 (FIG. 1). The eighth variable importance 196 and ninth variable importance 198 can generally be implemented in conjunction with any of the embodiments described herein, for example the digital outreach process 100 (FIG. 1), the method 300 (FIG. 2), method 320 (FIG. 3), standardized coefficient magnitudes scale 150 (FIG. 4), first variable importance 160 (FIG. 5A), second variable importance 170 (FIG. 5B), third and fourth variable importance 180, 182 (FIG. 5C), fifth variable importance 190 (FIG. 5D), sixth variable importance 192 (FIG. 5E), and/or seventh variable importance 194 (FIG. 5E).

In this example, a third gradient boosting machine (can be a base model such as Gradient Boosting Machine 3 listed in the standardized coefficient magnitudes scale 150 (FIG. 4)) receives different factors illustrated in eighth variable importance 196. The factors are weighted with a “scaled importance” as shown to increase the effectiveness of the Gradient Boosting Machine 3. The scaled importance can weigh the different factors. The factors can be from the pre-preprocessed data, which can be the pre-preprocessed data 112. The Gradient Boosting Machine 3 can receive the factors and generate a probability (e.g., digital propensity) based on the factors.

In this example, a fourth gradient boosting machine (can be a base model such as Gradient Boosting Machine 4) receives different factors illustrated in ninth variable importance 198. The factors are weighted with a “scaled importance” as shown to increase the effectiveness of the Gradient Boosting Machine 4. The scaled importance can weigh the different factors. The factors can be from the pre-preprocessed data, which can be the pre-preprocessed data 112. The Gradient Boosting Machine 4 can have little influence over the entire decision-making process as the Gradient Boosting Machine 4 has a standardized coefficient magnitude in the standardized coefficient magnitudes scale 150 of zero. The Gradient Boosting Machine 49 can receive the factors and generate a probability (e.g., digital propensity) based on the factors.

FIG. 5G illustrates tenth variable importance 200 and eleventh variable importance 202 to weigh different variables (e.g., factors) such as pre-processed data (pre-preprocessed data 112 of FIG. 1) provided to base models 104 (FIG. 1). The tenth variable importance 200 and eleventh variable importance 202 can generally be implemented in conjunction with any of the embodiments described herein, for example the digital outreach process 100 (FIG. 1), the method 300 (FIG. 2), method 320 (FIG. 3), standardized coefficient magnitudes scale 150 (FIG. 4), first variable importance 160 (FIG. 5A), second variable importance 170 (FIG. 5B), third and fourth variable importance 180, 182 (FIG. 5C), fifth variable importance 190 (FIG. 5D) sixth variable importance 192 (FIG. 5E), seventh variable importance 194 (FIG. 5E), eighth variable importance 196 (FIG. 5F), and/or ninth variable importance 198 (FIG. 5F).

In this example, a fifth gradient boosting machine (can be a base model such as Gradient Boosting Machine 5 listed in the standardized coefficient magnitudes scale 150 (FIG. 4)) receives different factors illustrated in tenth variable importance 200. The factors are weighted with a “scaled importance” as shown to increase the effectiveness of the Gradient Boosting Machine 5. The scaled importance can weigh the different factors. The factors can be from the pre-preprocessed data, which can be the pre-preprocessed data 112. The Gradient Boosting Machine 5 can have little influence over the entire decision-making process as the Gradient Boosting Machine 5 has a standardized coefficient magnitude in the standardized coefficient magnitudes scale 150 of zero. The Gradient Boosting Machine 5 can receive the factors and generate a probability (e.g., digital propensity) based on the factors.

In this example, a Gradient Boosting Machine 6 (can be a base model such as Gradient Boosting Machine 6 listed in the standardized coefficient magnitudes scale 150 (FIG. 4)) receives different factors illustrated in eleventh variable importance 202. The factors are weighted with a “scaled importance” as shown to increase the effectiveness of the Gradient Boosting Machine 6. The factors can be from the pre-preprocessed data, which can be the pre-preprocessed data 112. The scaled importance can weigh the different factors. The Gradient Boosting Machine 6 can have little influence over the entire decision-making process as the Gradient Boosting Machine 6 has a standardized coefficient magnitude in the standardized coefficient magnitudes scale 150 of zero. The Gradient Boosting Machine 6 can receive the factors and generate a probability (e.g., digital propensity) based on the factors.

FIG. 5H illustrates twelfth variable importance 204 and thirteenth variable importance 206 to weigh different variables (e.g., factors) such as pre-processed data (pre-preprocessed data 112 of FIG. 1) provided to base models 104 (FIG. 1). The twelfth variable importance 204 and thirteenth variable importance 206 can generally be implemented in conjunction with any of the embodiments described herein, for example the digital outreach process 100 (FIG. 1), the method 300 (FIG. 2), method 320 (FIG. 3) and/or standardized coefficient magnitudes scale 150 (FIG. 4), first variable importance 160 (FIG. 5A), second variable importance 170 (FIG. 5B), third and fourth variable importance 180, 182 (FIG. 5C), fifth variable importance 190 (FIG. 5D), sixth variable importance 192 (FIG. 5E), seventh variable importance 194 (FIG. 5E), eighth variable importance 196 (FIG. 5F), ninth variable importance 198 (FIG. 5F), tenth variable importance 200 (FIG. 5G) and/or eleventh variable importance 202 (FIG. 5G).

In this example, a distributed random forest classifier model (can be a base model such as Distributed Random Forest Classifier Model 2 listed in the standardized coefficient magnitudes scale 150 (FIG. 4)) receives different factors illustrated in twelfth variable importance 204. The factors are weighted with a “scaled importance” as shown to increase the effectiveness of the Distributed Random Forest Classifier Model 2. The scaled importance can weigh the different factors. The factors can be from the pre-preprocessed data, which can be the pre-preprocessed data 112. The Distributed Random Forest Classifier Model 2 can have little influence over the entire decision-making process as the Distributed Random Forest Classifier Model 2 has a standardized coefficient magnitude in the standardized coefficient magnitudes scale 150 of zero. The Distributed Random Forest Classifier Model 2 can receive the factors and generate a probability (e.g., digital propensity) based on the factors.

In this example, a gradient boosting machine (can be a base model such as Gradient Boosting Machine 7 listed in the standardized coefficient magnitudes scale 150 (FIG. 4)) receives different factors illustrated in thirteenth variable importance 206. The factors are weighted with a “scaled importance” as shown to increase the effectiveness of the Gradient Boosting Machine 7. The scaled importance can weigh the different factors. The factors can be from the pre-preprocessed data, which can be the pre-preprocessed data 112. The Gradient Boosting Machine 7 model can receive the factors and a probability (e.g., digital propensity) based on the factors.

FIG. 5I illustrates fourteenth variable importance 208 and fifteenth variable importance 210 to weigh different variables (e.g., factors) such as pre-processed data (pre-preprocessed data 112 of FIG. 1) provided to base models 104 (FIG. 1). The fourteenth variable importance 208 and fifteenth variable importance 210 can generally be implemented in conjunction with any of the embodiments described herein, for example the digital outreach process 100 (FIG. 1), the method 300 (FIG. 2), method 320 (FIG. 3) and/or standardized coefficient magnitudes scale 150 (FIG. 4), first variable importance 160 (FIG. 5A), second variable importance 170 (FIG. 5B), third and fourth variable importance 180, 182 (FIG. 5C), fifth variable importance 190 (FIG. 5D), sixth variable importance 192 (FIG. 5E), seventh variable importance 194 (FIG. 5E), eighth variable importance 196 (FIG. 5F), ninth variable importance 198 (FIG. 5F), tenth variable importance 200 (FIG. 5G), eleventh variable importance 202 (FIG. 5G), twelfth variable importance 204 (FIG. 5H) and thirteenth variable importance 206 (FIG. 5H).

In this example, a gradient boosting machine (can be a base model such as Gradient Boosting Machine 8 listed in the standardized coefficient magnitudes scale 150 (FIG. 4)) receives different factors illustrated in fourteenth variable importance 208. The factors are weighted with a “scaled importance” as shown to increase the effectiveness of the Gradient Boosting Machine 8. The scaled importance can weigh the different factors. The factors can be from the pre-preprocessed data, which can be the pre-preprocessed data 112. The Gradient Boosting Machine 8 can receive the factors and generate a probability (e.g., digital propensity) based on the factors.

In this example, a fifth deep learning model (can be a base model such as Deep Learning Model 5 listed in the standardized coefficient magnitudes scale 150 (FIG. 4)) receives different factors illustrated in fifteenth variable importance 210. The factors are weighted with a “scaled importance” as shown to increase the effectiveness of the Deep Learning Model 5. The scaled importance can weigh the different factors. The factors can be from the pre-preprocessed data, which can be the pre-preprocessed data 112. The Deep Learning Model 5 model can receive the factors and generate a probability (e.g., digital propensity) based on the factors.

FIG. 5J illustrates sixteenth variable importance 212 to weigh different variables (e.g., factors) such as pre-processed data (pre-preprocessed data 112 of FIG. 1) provided to base models 104 (FIG. 1). The sixteenth variable importance 212 can generally be implemented in conjunction with any of the embodiments described herein, for example the digital outreach process 100 (FIG. 1), the method 300 (FIG. 2), method 320 (FIG. 3) and/or standardized coefficient magnitudes scale 150 (FIG. 4), first variable importance 160 (FIG. 5A), second variable importance 170 (FIG. 5B), third and fourth variable importance 180, 182 (FIG. 5C), fifth variable importance 190 (FIG. 5D), sixth variable importance 192 (FIG. 5E), seventh variable importance 194 (FIG. 5E), eighth variable importance 196 (FIG. 5F), ninth variable importance 198 (FIG. 5F), tenth variable importance 200 (FIG. 5G) eleventh variable importance 202 (FIG. 5G), twelfth variable importance 204 (FIG. 5H), thirteenth variable importance 206 (FIG. 5H), fourteenth variable importance 208 (FIG. 5I) and/or fifteenth variable importance 210 (FIG. 5I).

In this example, a sixth deep learning model (can be a base model such as Deep Learning Model 6 listed in the standardized coefficient magnitudes scale 150 (FIG. 4)) receives different factors illustrated in sixteenth variable importance 212. The factors are weighted with a “scaled importance” as shown to increase the effectiveness of the deep learning model. The scaled importance can weigh the different factors. The factors can be from the pre-preprocessed data, which can be the pre-preprocessed data 112. The Deep Learning Model 6 can receive the factors and generate a probability (e.g., digital propensity) based on the factors.

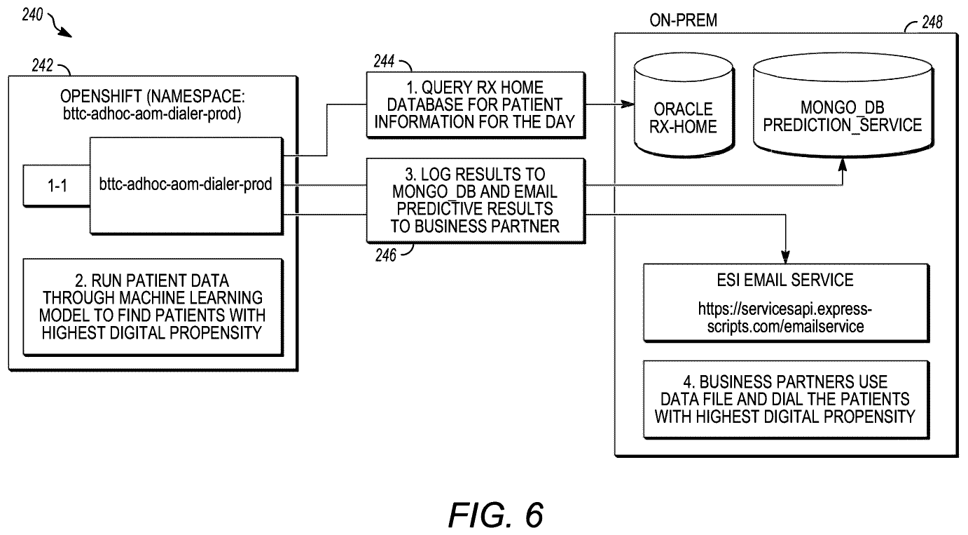

FIG. 6 illustrates a process 240 to execute an automated contacting process as described herein. The twelfth variable importance 204 can generally be implemented in conjunction with any of the embodiments described herein, for example the digital outreach process 100 (FIG. 1), the method 300 (FIG. 2), method 320 (FIG. 3), standardized coefficient magnitudes scale 150 (FIG. 4), first variable importance 160 (FIG. 5A), second variable importance 170 (FIG. 5B), third and fourth variable importance 180, 182 (FIG. 5C), fifth variable importance 190 (FIG. 5D), sixth variable importance 192 (FIG. 5E), seventh variable importance 194 (FIG. 5E), eighth variable importance 196 (FIG. 5F), ninth variable importance 198 (FIG. 5F), tenth variable importance 200 (FIG. 5G), eleventh variable importance 202 (FIG. 5G), twelfth variable importance 204 (FIG. 5H), thirteenth variable importance 206 (FIG. 5H), fourteenth variable importance 208 (FIG. 5I), fifteenth variable importance 210 (FIG. 5I) and/or sixteenth variable importance 212 (FIG. 5J).

Illustrated processing block 242 can include running patient data through machine learning to find patients with a highest digital propensity. Illustrated processing block 244 queries a medical home database for patient information for the day (e.g., Oracle® home).

Illustrated processing block 246 logs the results back to a database and emails predictive results to a business partner. The on-premise architecture 248 includes an ESI email service, and business partners use data file and dial the patient with highest digital propensity.

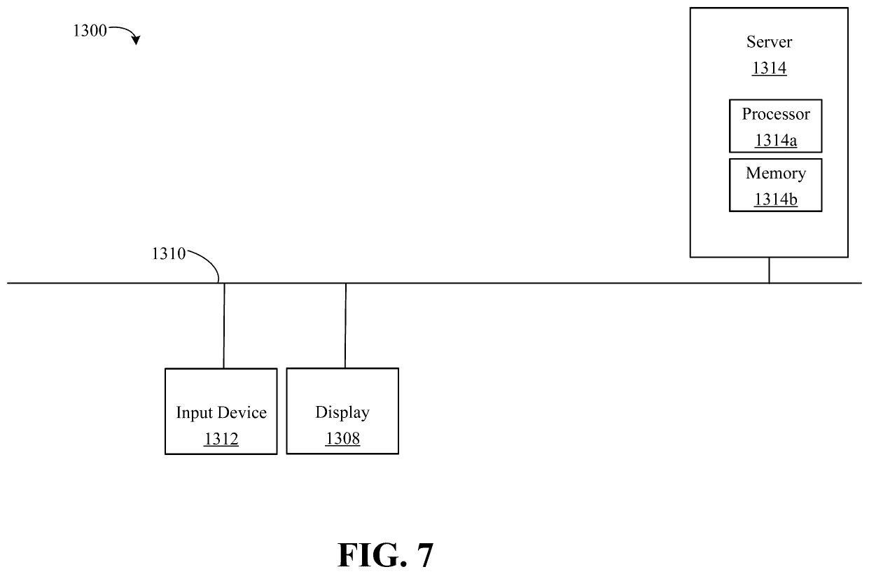

FIG. 7 shows a more detailed example of a computing architecture 1300 to execute a digital communication process. The computing architecture 1300 can generally be implemented in conjunction with any of the examples described herein, for example the digital outreach process 100 (FIG. 1), the method 300 (FIG. 2), method 320 (FIG. 3), standardized coefficient magnitudes scale 150 (FIG. 4), first variable importance 160 (FIG. 5A), second variable importance 170 (FIG. 5B), third and fourth variable importance 180, 182 (FIG. 5C), fifth variable importance 190 (FIG. 5D), sixth variable importance 192 (FIG. 5E), seventh variable importance 194 (FIG. 5E), eighth variable importance 196 (FIG. 5F), ninth variable importance 198 (FIG. 5F), tenth variable importance 200 (FIG. 5G), eleventh variable importance 202 (FIG. 5G), twelfth variable importance 204 (FIG. 5H) and thirteenth variable importance 206 (FIG. 5H), fourteenth variable importance 208 (FIG. 5I), fifteenth variable importance 210 (FIG. 5I), sixteenth variable importance 212 (FIG. 5J) and/or process 240 (FIG. 6).

In the illustrated example, the computing architecture 1300 can include a network 1310 that can facilitate communication between server 1314, input device 1312, and display 1308. The display 1308 (e.g., audio and/or visual interface) can present notifications through an automated digital process to a user, and the input device 1312 can receive user inputs (e.g., download application in notification to computing device, respond to notification, etc.).

The server 1314 includes a processor 1314a (e.g., embedded controller, central processing unit/CPU) and a memory 1314b (e.g., non-volatile memory/NVM and/or volatile memory) containing a set of instructions, which when executed by the processor 1314a, cause the server 1314 to implement aspects described herein to execute the automated digital communication, and can executed a stacked ensemble, such as stacked ensemble 114 (FIG. 1), pre-processing of data and automated notifications.

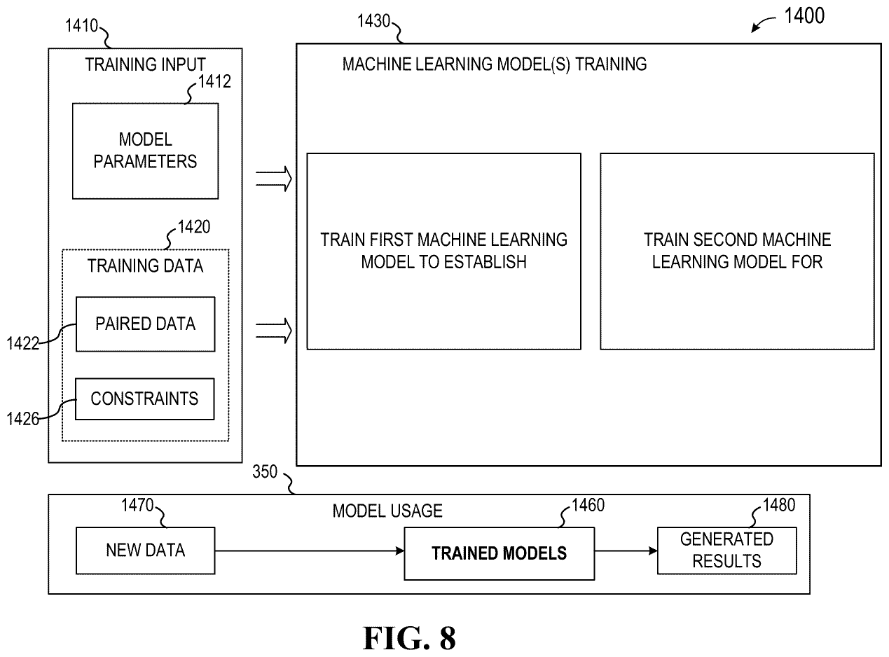

FIG. 8 is a block diagram of an example service of enhanced automated communication process/system 1400 that may be deployed within and/or in conjunction with the examples herein, including digital outreach process 100 (FIG. 1), the method 300 (FIG. 2), method 320 (FIG. 3), standardized coefficient magnitudes scale 150 (FIG. 4), first variable importance 160 (FIG. 5A), second variable importance 170 (FIG. 5B), third and fourth variable importance 180, 182 (FIG. 5C), fifth variable importance 190 (FIG. 5D), sixth variable importance 192 (FIG. 5E), seventh variable importance 194 (FIG. 5E), eighth variable importance 196 (FIG. 5F), ninth variable importance 198 (FIG. 5F), tenth variable importance 200 (FIG. 5G), eleventh variable importance 202 (FIG. 5G), twelfth variable importance 204 (FIG. 5H), thirteenth variable importance 206 (FIG. 5H), fourteenth variable importance 208 (FIG. 5I), fifteenth variable importance 210 (FIG. 5I), sixteenth variable importance 212 (FIG. 5J), process 240 (FIG. 6) and/or computing architecture 1300 (FIG. 7). Training input 1410 includes model parameters 1412 and training data 1420, which may include paired training data sets 1422 (e.g., input-output training pairs) and constraints 1426. Model parameters 1412 store or provide the parameters or coefficients of corresponding ones of machine learning models. During training, these parameters 1412 are adapted based on the input-output training pairs of the training data sets 1422. After the parameters 1412 are adapted (after training), the parameters are used by trained models 1460 to implement the trained machine learning models on a new set of data 1470 from model usage 350.

Training data 1420 includes constraints 1426 which may define the constraints of a given patient information features. The paired training data sets 1422 may include sets of input-output pairs, such as pairs of a plurality of training virtual telehealth encounter transcription features and features of post patient encounter documents that are created in association with one or more of the training transcriptions (e.g., ground-truth patient encounter documentation of successful digital reach out strategies and unsuccessful digital reach out strategies). Some components of training input 1410 may be stored separately at a different off-site facility or facilities than other components.

Machine learning model(s) training 1430 trains one or more machine learning techniques based on the sets of input-output pairs of paired training data sets 1422. For example, the model training 1430 may train the machine learning (ML) model parameters 1412 by minimizing a loss function based on one or more ground-truth patient encounter documents generated in association with a training transcription. The ML model can include any one or combination of classifiers or neural networks, such as an artificial neural network, a convolutional neural network, an adversarial network, a generative adversarial network, a deep feed forward network, a radial basis network, a recurrent neural network, a long/short term memory network, a gated recurrent unit, an auto encoder, a variational autoencoder, a denoising autoencoder, a sparse autoencoder, a Markov chain, a Hopfield network, a Boltzmann machine, a restricted Boltzmann machine, a deep belief network, a deep convolutional network, a deconvolutional network, a deep convolutional inverse graphics network, a liquid state machine, an extreme learning machine, an echo state network, a deep residual network, a Kohonen network, a support vector machine, a neural Turing machine, an LLM, a generative network, a diffusion model, and the like.

Particularly, the ML model can be applied to a training batch of transcription features to estimate or generate one or more preliminary patient digital outreach predictions and times. In some implementations, a derivative of a loss function is computed based on a comparison of the preliminary patient digital outreach predictions and times and the ground truth patient digital outreach associated with the training transcription features and parameters of the ML model are updated based on the computed derivative of the loss function.

The result of minimizing the loss function for multiple sets of training data trains, adapts, or optimizes the model parameters 1412 of the corresponding ML models. In this way, the ML model is trained to establish a relationship between a plurality of training transcriptions and ground-truth patient encounter documents associated with the training transcriptions.

After the machine learning model is trained, new data 1470, including one or user data 102 (FIG. 1) and/or pre-preprocessed data 112 (FIG. 1) can be provided. The trained machine learning model may be applied to the new data 1470 to generate results 1480 including times and probabilities. The times and probabilities can be represented in a graphical user interface (GUI), and/or provided to an automated communication system such as automated communication system 122 (FIG. 1) to execute or bypass the digital outreach.

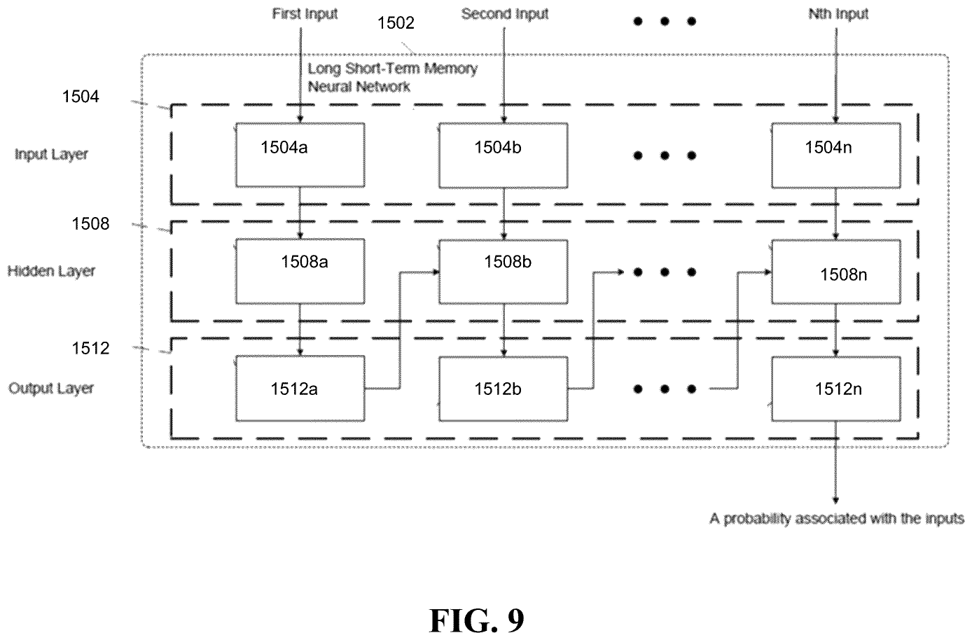

FIG. 9 is a functional block diagram of an example neural network 1502 that can be used for the inference engine or other functions (e.g., engines) as described herein to produce a predictive model. Neural network 1502 may be deployed within and/or in conjunction with the examples herein, digital outreach process 100 (FIG. 1), the method 300 (FIG. 2), method 320 (FIG. 3), standardized coefficient magnitudes scale 150 (FIG. 4), first variable importance 160 (FIG. 5A), second variable importance 170 (FIG. 5B), third and fourth variable importance 180, 182 (FIG. 5C), fifth variable importance 190 (FIG. 5D), sixth variable importance 192 (FIG. 5E), seventh variable importance 194 (FIG. 5E), eighth variable importance 196 (FIG. 5F), ninth variable importance 198 (FIG. 5F), tenth variable importance 200 (FIG. 5G), eleventh variable importance 202 (FIG. 5G), twelfth variable importance 204 (FIG. 5H), thirteenth variable importance 206 (FIG. 5H), fourteenth variable importance 208 (FIG. 5I), fifteenth variable importance 210 (FIG. 5I), sixteenth variable importance 212 (FIG. 5J), process 240 (FIG. 6) and/or computing architecture 1300 (FIG. 7), according to some examples. The predictive model can identify or generate characteristics of a conversation. In an example, the neural network 1502 can be a LSTM neural network. In an example, the neural network 1502 can be a recurrent neural network (RNN). The example neural network 1502 may be used to implement the machine learning as described herein, and various implementations may use other types of machine learning networks. The neural network 1502 includes an input layer 1504, a hidden layer 1508, and an output layer 1512. The input layer 1504 includes inputs 1504a, 1504b . . . 1504n. The hidden layer 1508 includes neurons 1508a, 1508b . . . 1508n. The output layer 1512 includes outputs 1512a, 1512b . . . 1512n.

Each neuron of the hidden layer 1508 receives an input from the input layer 1504 and outputs a value to the corresponding output in the output layer 1512. For example, the neuron 1508a receives an input from the input 1504a and outputs a value to the output 1512a. Each neuron, other than the neuron 1508a, also receives an output of a previous neuron as an input. For example, the neuron 1508b receives inputs from the input 1504b and the output 1512a. In this way the output of each neuron is fed forward to the next neuron in the hidden layer 1508. The last output 1512n in the output layer 1512 outputs a probability associated with the inputs 1504a-1504n. Although the input layer 1504, the hidden layer 1508, and the output layer 1512 are depicted as each including three elements, each layer may contain any number of elements. Neurons can include one or more adjustable parameters, weights, rules, criteria, or the like.

In various implementations, each layer of the neural network 1502 must include the same number of elements as each of the other layers of the neural network 1502. For example, training GUI features (e.g., fields of a GUI presented to an operator) may be processed to create the inputs 1504a-1504n. The neural network 1502 may implement a model to produce one or more preliminary post patient encounter document in association with user features. More specifically, the inputs 1504a-1504n can include fields of the user features as data features (binary, vectors, factors or the like) stored in the storage device. The fields of the user features as data features can be provided to neurons 1508a-1508n for analysis and connections between the known facts. The neurons 1508a-1508n, upon finding connections, provides the potential connections as outputs to the output layer 1512, which determines a preliminary post patient encounter document.

The neural network 1502 can perform any of the above calculations. The output of the neural network 1502 can be used to determine whether and when to contact a user digitally.

In some examples, a convolutional neural network may be implemented. Similar to neural networks, convolutional neural networks include an input layer, a hidden layer, and an output layer. However, in a convolutional neural network, the output layer includes one fewer output than the number of neurons in the hidden layer and each neuron is connected to each output. Additionally, each input in the input layer is connected to each neuron in the hidden layer. In other words, input 1504a is connected to each of neurons 1508a, 1508b . . . 1508n.

The present systems and methods can process the audio and/or textual component of a conversation to assist in determining whether to execute a digital communication process. Times and/or the probability can be determined using the neural network (generative AI engine) associated with the conversation. An emotional state neural network can receive a loudness result, a pitch result, a tone result, or combinations thereof to determine an emotional state of the patient. The present system can use systems and methods from U.S. Pat. No. 11,031,013, which is assigned to the present assignee and incorporated herein by reference.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an ASIC. A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output.

Hardware components may also initiate communications with input or output devices (e.g., from the automated communication system to the patient devices or from the stacked ensemble engine to the automated communication system) and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

The term “coupled” can be used herein to refer to any type of relationship, direct or indirect, between the components in question, and can apply to electrical, mechanical, fluid, optical, electromagnetic, electromechanical or other connections. In addition, the terms “first”, “second”, etc. can be used herein only to facilitate discussion, and carry no particular temporal or chronological significance unless otherwise indicated.

Those skilled in the art will appreciate from the foregoing description that the broad techniques of the embodiments of the present disclosure can be implemented in a variety of forms. Therefore, while the embodiments of this disclosure have been described in connection with particular examples thereof, the true scope of the embodiments of the disclosure should not be so limited since other modifications will become apparent to the skilled practitioner upon a study of the drawings, specification, and following claims.

We claim:

1. A computing system comprising:
a processor; and
a memory having a set of instructions, which when executed by the processor, cause the computing system to:
identify a plurality of user factors associated with a user;
determine, with a machine learning model, a future time to contact the user based on the plurality of user factors;
determine, with a stacked ensemble, a probability that the user responds to digital outreach based on the plurality of user factors; and
initiate an automatic contacting process to contact the user at the future time based on the probability meeting a threshold.

2. The computing system of claim 1, wherein the automatic contacting process includes one or more of transmitting a text message to a computing device of the user, executing an automatic call to the computing device, transmitting an electronic mail to an email of the user, providing a notification through an application of the computing device, providing a notification through a website, transmitting a fax, providing a chat to the computing device or updating an electronic calendar of the user.

3. The computing system of claim 1,
wherein the machine learning model is a random forest classifier,
wherein the stacked ensemble comprises a plurality of machine learning models, and
wherein the future time is a range of times.

4. The computing system of claim 3, wherein the plurality of machine learning models of the stacked ensemble includes a random forest classifier, a support vector machine, a gradient boosting machine and a neural network.

5. The computing system of claim 3, wherein to determine the probability that the user responds to the digital outreach, the instructions of the memory, when executed, cause the computing system to:
identify weights associated with the plurality of machine learning models; and
determine the probability based on the weights being applied to outputs of the plurality of machine learning models.

6. The computing system of claim 1, wherein the plurality of user factors includes one or more of a disease of the user, whether the user has a pulmonary condition, a treatment of the user, a genetic disorder of the user, or a provider of the user.

7. The computing system of claim 1, wherein the instructions of the memory, when executed, cause the computing system to:
generate weighted factors by applying weights to the plurality of user factors; and
provide subsets of the weighted factors to the machine learning model and the stacked ensemble.

8. At least one non-transitory computer readable storage medium comprising a set of instructions, which when executed by a computing system, cause the computing system to:
identify a plurality of user factors associated with a user;
determine, with a machine learning model, a future time to contact the user based on the plurality of user factors;
determine, with a stacked ensemble, a probability that the user responds to digital outreach based on the plurality of user factors; and
initiate an automatic contacting process to contact the user at the future time based on the probability meeting a threshold.

9. The at least one non-transitory computer readable storage medium of claim 8, wherein the automatic contacting process includes one or more of transmitting a text message to a computing device of the user, executing an automatic call to the computing device, transmitting an electronic mail to an email of the user, providing a notification through an application of the computing device, providing a notification through a website, transmitting a fax, providing a chat to the computing device or updating an electronic calendar of the user.

10. The at least one non-transitory computer readable storage medium of claim 8,
wherein the machine learning model is a random forest classifier, and
wherein the stacked ensemble comprises a plurality of machine learning models, and
wherein the future time is a range of times.

11. The at least one non-transitory computer readable storage medium of claim 10, wherein the plurality of machine learning models of the stacked ensemble includes a random forest classifier, a support vector machine, a gradient boosting machine and a neural network.

12. The at least one non-transitory computer readable storage medium of claim 10, wherein to determine the probability that the user responds to the digital outreach, the instructions, when executed, cause the computing system to:
identify weights associated with the plurality of machine learning models; and
determine the probability based on the weights being applied to outputs of the plurality of machine learning models.

13. The at least one non-transitory computer readable storage medium of claim 8, wherein the plurality of user factors includes one or more of a disease of the user, whether the user has a pulmonary condition, a treatment of the user, a genetic disorder of the user, or a provider of the user.

14. The at least one non-transitory computer readable storage medium of claim 8, wherein to determine, with the stacked ensemble, the future time, the instructions, when executed, cause the computing system to:
generate weighted factors by applying weights to the plurality of user factors; and
provide subsets of the weighted factors to the machine learning model and the stacked ensemble.

15. A method comprising:
identifying a plurality of user factors associated with a user;
determining, with a machine learning model, a future time to contact the user based on the plurality of user factors;
determining, with a stacked ensemble, a probability that the user responds to digital outreach based on the plurality of user factors; and
initiating an automatic contacting process to contact the user at the future time based on the probability meeting a threshold.

16. The method of claim 15, wherein the automatic contacting process includes one or more of transmitting a text message to a computing device of the user, executing an automatic call to the computing device, transmitting an electronic mail to an email of the user, providing a notification through an application of the computing device, providing a notification through a website, transmitting a fax, providing a chat to the computing device or updating an electronic calendar of the user.

17. The method of claim 15,
wherein the machine learning model is a random forest classifier,
wherein the stacked ensemble comprises a plurality of machine learning models, and
wherein the future time is a range of times.

18. The method of claim 17, wherein the plurality of machine learning models of the stacked ensemble includes a random forest classifier, a support vector machine, a gradient boosting machine and a neural network.

19. The method of claim 17, wherein the determining the probability that the user responds to the digital outreach comprises:
identifying weights associated with the plurality of machine learning models; and
determining the probability based on the weights being applied to outputs of the plurality of machine learning models.

20. The method of claim 15, further comprising:
generating weighted factors by applying weights to the plurality of user factors; and
providing subsets of the weighted factors to the machine learning model and the stacked ensemble,
wherein the plurality of user factors includes one or more of a disease of the user, whether the user has a pulmonary condition, a treatment of the user, a genetic disorder of the user, or a provider of the user.
